(19) United States
(12) Patent Application Publication
(10) Pub. No.: US 2024/0298217 A1
(43) Pub. Date: Sep. 5, 2024

(54) COMMUNICATION METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/646,898

(22) Filed: Apr. 26, 2024

Related U.S. Application Data
(63) Continuation of application No. PCT/JP2022/039139, filed on Oct. 20, 2022.

(30) Foreign Application Priority Data
Oct. 29, 2021 (JP) 2021-178062

(51) Int. Cl. H04W 36/00; H04W 4/06

(52) U.S. Cl. CPC H04W 36/0007; H04W 4/06; H04W 36/0061

(57) ABSTRACT

A communication method performed by a UE in a mobile communication system for providing a multicast and broadcast service (MBS) includes: receiving an MBS signal transmitted from a plurality of cells included in a single frequency network (SFN) by using an identical identifier; measuring reception quality of the MBS signal using the identical identifier as a measurement target; and reporting, to a network, a measurement result obtained by the measurement.

### RELATED APPLICATIONS

The present application is a continuation based on PCT Application No. PCT/JP2022/039139, filed on Oct. 20, 2022, which claims the benefit of Japanese Patent Application No. 2021-178062 filed on Oct. 29, 2021. The content of which is incorporated by reference herein in their entirety.

### TECHNICAL FIELD

The present disclosure relates to a communication method used in a mobile communication system.

### BACKGROUND

In 3rd Generation Partnership Project (3GPP) standards, technical specifications of New Radio (NR) being radio access technology of the fifth generation (5G) have been defined. NR has features such as high speed, large capacity, high reliability, and low latency, in comparison to Long Term Evolution (LTE) being radio access technology of the fourth generation (4G). In 3GPP, there have been discussions for designing technical specifications of multicast and broadcast services (MBS) of 5G/NR (for example, see Non-Patent Document 1).

### CITATION LIST

### Non-Patent Literature

Non-Patent Document 1: 3GPP Contribution: RP-201038, “WID revision: NR Multicast and Broadcast Services”

### SUMMARY

5G/NR multicast and broadcast services are desired to provide enhanced services compared to 4G/LTE multicast and broadcast services.

The present disclosure enables an improved multicast and broadcast service.

In a first aspect, a communication method is a method performed by a user equipment in a mobile communication system for providing a multicast and broadcast service (MBS). The communication method includes: receiving an MBS signal transmitted from a plurality of cells included in a single frequency network (SFN) by using an identical identifier; measuring reception quality of the MBS signal using the identical identifier as a measurement target; and reporting, to a network, a measurement result obtained by the measurement.

In a second aspect, a communication method is a method performed by a user equipment in a radio resource control (RRC) idle state or an RRC inactive state in a mobile communication system for providing a multicast and broadcast service (MBS). The communication method includes: receiving an MBS signal transmitted using an identical identifier from a plurality of cells included in a single frequency network (SFN); and performing, in a cell reselection procedure, priority control of prioritizing cells included in the SFN over cells not included in the SFN.

In a third aspect, a communication method is a method performed by a user equipment in a mobile communication system for providing a multicast and broadcast service (MBS). The communication method includes: receiving, in a radio resource control (RRC) connected state, an MBS reception configuration transmitted by dedicated signaling from a network to a user equipment; and performing MBS reception using the MBS reception configuration for a predetermined amount of time after transitioning to an RRC idle state or an RRC inactive state.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an overview of MBS traffic delivery according to an embodiment.

FIG. 7 is a diagram illustrating delivery modes according to an embodiment.

FIG. 8 is a diagram illustrating an example of internal processing related to MBS reception of a UE according to an embodiment.

FIG. 9 is a diagram illustrating another example of internal processing related to the MBS reception of the UE according to an embodiment.

FIG. 10 is a diagram illustrating a single frequency network (SFN) according to an embodiment.

FIG. 11 is a diagram illustrating a first operation scenario of the mobile communication system according to an embodiment.

FIG. 12 is a diagram illustrating a second operation scenario of the mobile communication system according to an embodiment.

FIG. 13 is a diagram illustrating a first operation example according to a first embodiment.

FIG. 14 is a diagram illustrating a second operation example according to the first embodiment.

FIG. 15 is a diagram illustrating a general flow of a typical cell reselection procedure.

FIG. 16 is a diagram illustrating an operation example according to a second embodiment.

FIG. 17 is a diagram illustrating an operation example according to a third embodiment.

### DESCRIPTION OF EMBODIMENTS

A mobile communication system according to an embodiment is described with reference to the drawings. In the description of the drawings, the same or similar parts are denoted by the same or similar reference signs.

### First Embodiment

### Configuration of Mobile Communication System

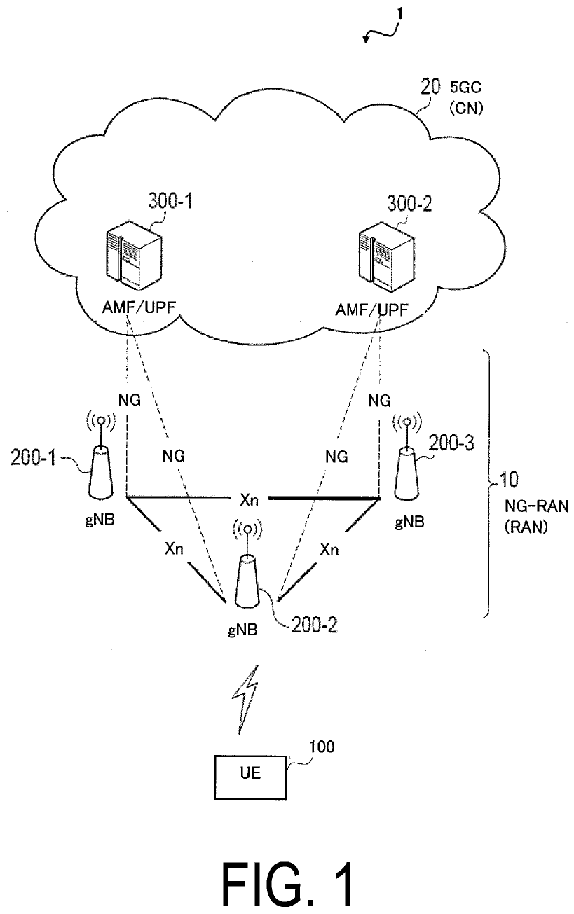

FIG. 1 is a diagram illustrating a configuration of a mobile communication system according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

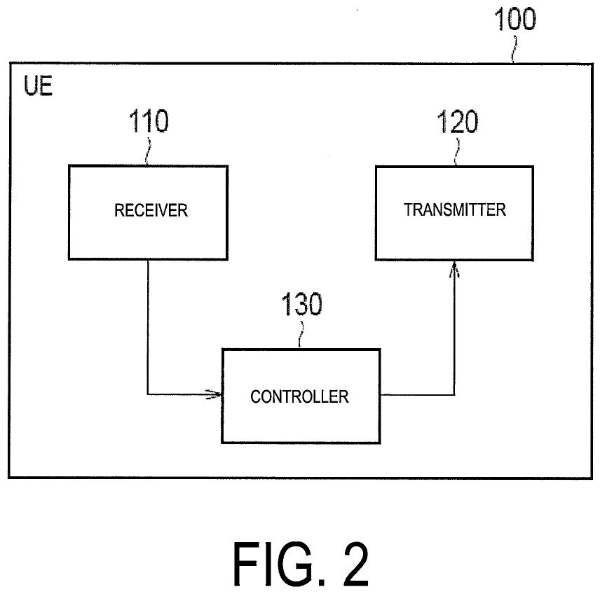

FIG. 2 is a diagram illustrating a configuration of the UE 100 (user equipment) to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. A reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processes include processes of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

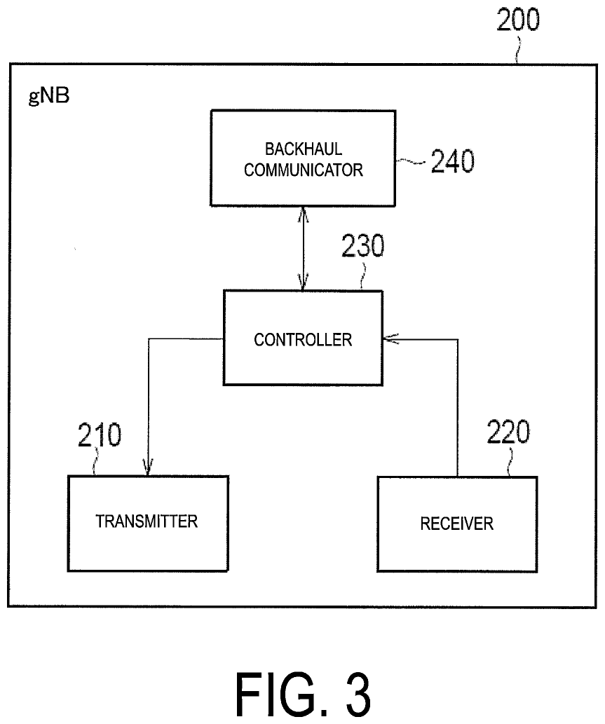

FIG. 3 is a diagram illustrating a configuration of the gNB 200 (base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processes include processes of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface between base stations. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

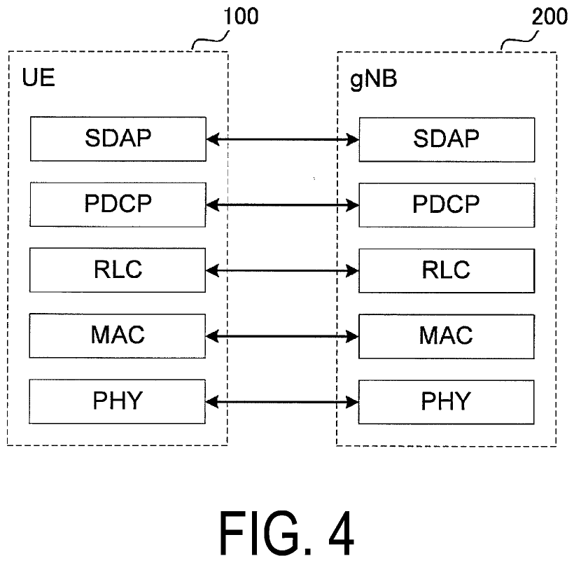

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

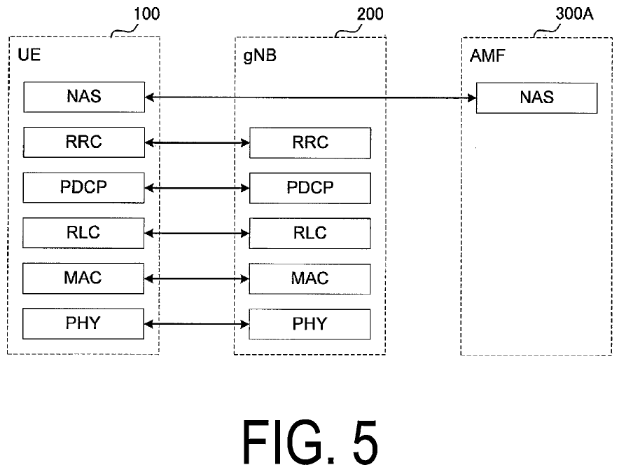

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### Overview of MBS

An overview of the MBS according to an embodiment will be provided. The MBS is a service in which the NG-RAN 10 can provide broadcast or multicast, i.e., Point To Multipoint (PTM) data transmission to the UE 100. Assumed use cases (service types) of the MBS include public safety communication, mission critical communication, Vehicle to Everything (V2X) communication, IPv4 or IPv6 multicast delivery, Internet Protocol TeleVision (IPTV), group communication, and software delivery.

A broadcast service provides a service to every UE 100 within a particular service area for an application not requiring highly reliable QoS. An MBS session used for the broadcast service is referred to as a broadcast session.

A multicast service provides a service not to every UE 100, but to a group of UEs 100 participating in the multicast service (multicast session). An MBS session used for the multicast service is referred to as a multicast session.

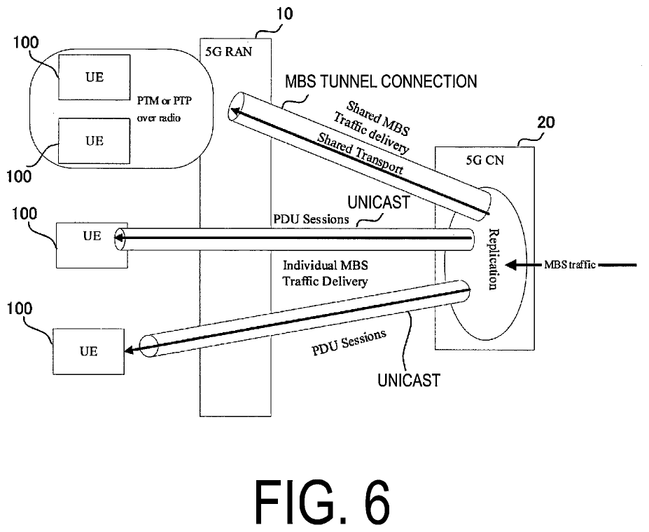

FIG. 6 is a diagram illustrating an overview of MBS traffic delivery according to an embodiment.

MBS traffic (MBS data) is delivered from a single data source (application service provider) to a plurality of UEs. The 5G CN (5GC) 20, which is a 5G core network, receives the MBS data from the application service provider and performs Replication of the MBS data to deliver the resultant.

From the perspective of the 5GC 20, two multicast delivery methods are possible: 5GC Shared MBS Traffic delivery and 5GC Individual MBS Traffic delivery.

In the 5GC individual MBS traffic delivery method, the 5GC 20 receives a single copy of MBS data packets and delivers individual copies of these MBS data packets to the individual UEs 100 via PDU sessions of the individual UEs 100. Thus, one PDU session for each UE 100 needs to be associated with a multicast session.

In the 5GC shared MBS traffic delivery method, the 5GC 20 receives a single copy of MBS data packets and delivers the single copy of the MBS packets to a RAN node (i.e., the gNB 200). The gNB 200 receives the MBS data packets via MBS tunnel connection, and delivers those to one or more UEs 100.

From the perspective of the RAN (5G RAN) 10, two delivery methods are possible for radio transmission of the MBS data in the 5GC shared MBS traffic delivery method: a Point-To-Point (PTP) delivery method and a Point-To-Multipoint (PTM) delivery method. PTP means unicast, and PTM means multicast and broadcast.

In the PTP delivery method, the gNB 200 wirelessly delivers the individual copies of the MBS data packets to the individual UEs 100. On the other hand, in the PTM delivery method, the gNB 200 wirelessly delivers the single copy of the MBS data packets to a group of the UEs 100. The gNB 200 can dynamically determine whether to use the PTM or PTP delivery method as a method for delivering the MBS data to one UE 100.

The PTP and PTM delivery methods are mainly related to the user plane. Modes for controlling the MBS data delivery include two delivery modes: a first delivery mode and a second delivery mode.

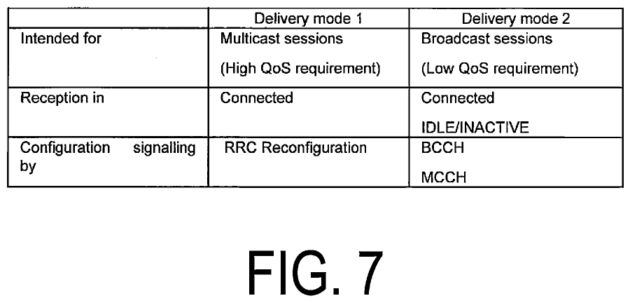

FIG. 7 is a diagram illustrating delivery modes according to an embodiment.

The first delivery mode (Delivery mode 1 (DM1)) is a delivery mode that can be used by the UE 100 in the RRC connected state, and is a delivery mode for high QoS requirements. The first delivery mode is used for multicast sessions among MBS sessions. Note that the first delivery mode may be used for broadcast sessions. The first delivery mode may be available to the UE 100 in the RRC idle state or the RRC inactive state.

MBS reception configuration in the first delivery mode is performed through UE-dedicated signaling. For example, the MBS reception configuration in the first delivery mode is performed through an RRC Reconfiguration message (or an RRC Release message), which is an RRC message unicast from the gNB 200 to the UE 100.

The MBS reception configuration includes MBS traffic channel configuration information (hereinafter referred to as “MTCH configuration information”) related to configuration of an MBS traffic channel transmitting MBS data. The MTCH configuration information includes MBS session information related to an MBS session (and including an MBS session identifier described below) and scheduling information of an MTCH corresponding to the MBS session. The scheduling information of the MTCH may include a discontinuous reception (DRX) configuration of the MTCH. The discontinuous reception configuration may include at least one parameter of a timer value (On Duration Timer) for defining an on-period (On Duration: reception period), a timer value (Inactivity Timer) for extending the on-period, a scheduling interval or a DRX cycle (Scheduling Period, DRX Cycle), an offset value (Start Offset, DRX Cycle Offset) of a start subframe for scheduling or a DRX cycle, a start delay slot value (Slot Offset) of an on-period timer, a timer value (Retransmission Timer) for defining a maximum time until retransmission, and a timer value (HARQ RTT Timer) for defining a minimum interval until DL assignment of HARQ retransmission. Note that the multicast traffic channel (MTCH) is a type of logical channel. The MTCH is mapped to a downlink shared channel (Down Link-Shared CHannel (DL-SCH)) being a type of transport channel.

The second delivery mode (Delivery mode 2 (DM2)) is a delivery mode that can be used not only by the UE 100 in the RRC connected state, but also by the UE 100 in the RRC idle state or the RRC inactive state, and is a delivery mode for low QoS requirements. The second delivery mode is used for broadcast sessions among MBS sessions. However, the second delivery mode may also be applicable to multicast sessions.

An MBS reception configuration in the second delivery mode is performed through broadcast signaling. For example, the MBS reception configuration in the second delivery mode is performed using a logical channel transmitted from the gNB 200 to the UE 100 through broadcast, for example, a broadcast control channel (BCCH) and/or a multicast control channel (MCCH). The UE 100 can receive the BCCH and the MCCH, using a dedicated RNTI defined in technical specifications in advance, for example. The RNTI for BCCH reception may be an SI-RNTI, and the RNTI for MCCH reception may be an MCCH-RNTI.

In the second delivery mode, the UE 100 may receive the MBS data in the following three procedures. Firstly, the UE 100 receives MCCH configuration information on an MBS system information block (MBS SIB) transmitted from the gNB 200 on the BCCH. Secondly, the UE 100 receives the MCCH from the gNB 200, based on the MCCH configuration information. On the MCCH, MTCH configuration information is transmitted. The MCCH may include neighboring cell information indicating whether the currently provided MBS session is also provided in a neighboring cell. Thirdly, the UE 100 receives the MTCH (MBS data), based on the MTCH configuration information. The MTCH configuration information and/or the MCCH configuration information may be hereinafter referred to as the MBS reception configuration.

In the first delivery mode and the second delivery mode, the UE 100 may receive the MTCH, using a group RNTI (G-RNTI) assigned from the gNB 200. The G-RNTI corresponds to an RNTI for MTCH reception. The G-RNTI may be included in the MBS reception configuration (MTCH configuration information).

The network can provide different MBS services for different MBS sessions. The MBS session is identified by at least one selected from the group consisting of a Temporary Mobile Group Identity (TMGI), a source-specific IP multicast address (which consists of a source unicast IP address, such as an application function and an application server, and an IP multicast address indicating a destination address), a session identifier, and a G-RNTI. At least one selected from the group consisting of the TMGI, the source specific IP multicast address, and the session identifier is referred to as an MBS session identifier. The TMGI, the source-specific IP multicast address, the session identifier, and the G-RNTI are collectively referred to as MBS session information.

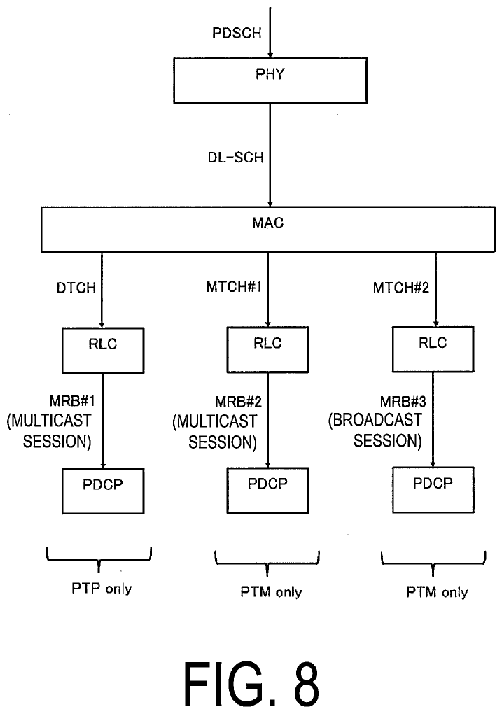

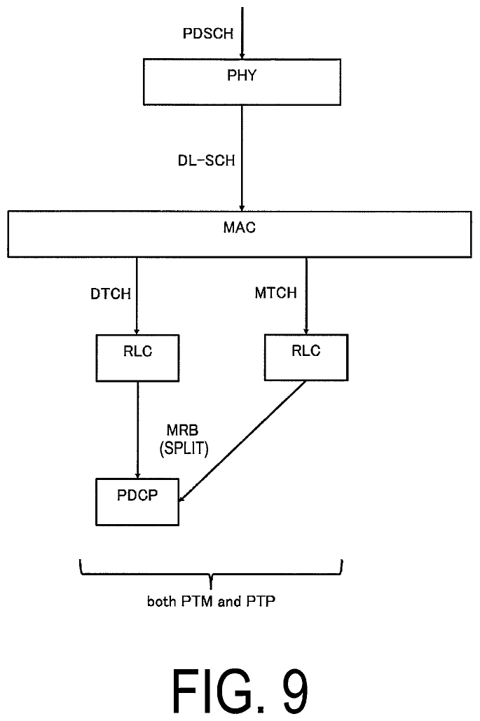

FIG. 8 is a diagram illustrating an example of internal processing related to MBS reception of the UE 100 according to an embodiment. FIG. 9 is a diagram illustrating another example of internal processing related to the MBS reception of the UE 100 according to an embodiment.

One MBS radio bearer (MRB) is one radio bearer for transmitting a multicast session or a broadcast session. In other words, the MRB may be associated with a multicast session or a broadcast session.

The MRB and the corresponding logical channel (e.g., MTCH) are configured by the gNB 200 for the UE 100 through RRC signaling. A configuration procedure for the MRB may be separated from a configuration procedure for a data radio bearer (DRB). In the RRC signaling, one MRB can be configured with “PTM only”, “PTP only”, or “both PTM and PTP”. The bearer types described above of the MRB may be changed by RRC signaling.

FIG. 8 illustrates an example in which MRB #1 is associated with a multicast session and a dedicated traffic channel (DTCH), MRB #2 is associated with a multicast session and MTCH #1, and MRB #3 is associated with a broadcast session and MTCH #2. In other words, MRB #1 is a PTP only MRB, MRB #2 is a PTM only MRB, and MRB #3 is a PTM only MRB. Note that the DTCH is scheduled using a cell RNTI (C-RNTI). The MTCH is scheduled using the G-RNTI.

The PHY layer of the UE 100 processes user data (received data) received on the PDSCH, which is one of physical channels, and routes the processed user data to the downlink shared channel (DL-SCH), which is one of transport channels. The MAC layer (MAC entity) of the UE 100 processes the data received on the DL-SCH and routes the received data to a corresponding logical channel (corresponding RLC entity), based on a logical channel identifier (LCID) included in the header (MAC header) included in the received data.

FIG. 9 illustrates an example in which the DTCH and the MTCH are associated with the MRB associated with a multicast session. Specifically, one MRB is split into two legs, one leg is associated with the DTCH, and the other leg is associated with the MTCH. The two legs are combined at the PDCP layer (PDCP entity). In other words, the MRB is an MRB of both PTM and PTP. Such an MRB may be referred to as a split MRB.

### Operations According to First Embodiment

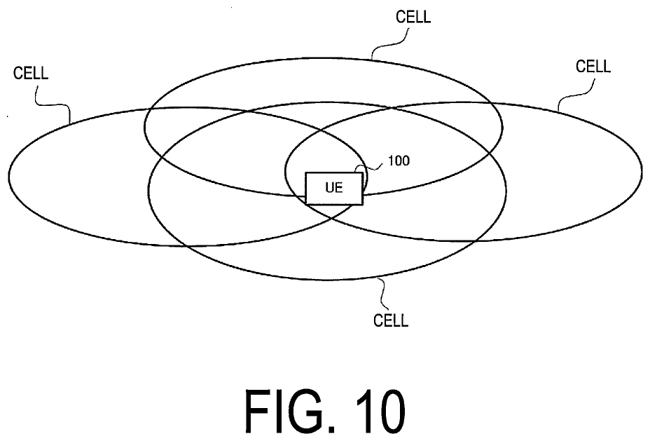

FIG. 10 is a diagram illustrating a single frequency network (SFN) according to a first embodiment.

In the first embodiment, a plurality of cells constitutes a single frequency network (SFN) for a certain MBS session. The cells included in the SFN simultaneously transmit the same MBS signal at the same frequency. Here, the MBS signal refers to a radio signal including MBS data and/or MBS control information. In the SFN, PTM (multicast/broadcast) transmission is performed using the same G-RNTI from a plurality of cells. The UE 100 located in an overlapping region of the plurality of cells combines and receives radio waves from the plurality of cells. Therefore, good MBS reception is easily achieved even when the UE 100 is located at a cell edge.

Note that, in the MBS, not only the SFN but any networks perform PTM transmission using a single cell or a plurality of cells in a certain area and thus that the cells included in the SFN may dynamically change to some extent. In the MBS, the network performs PTM transmission using a single cell or a plurality of cells for each service (MBS session), and thus the cells included in the SFN may vary for each service.

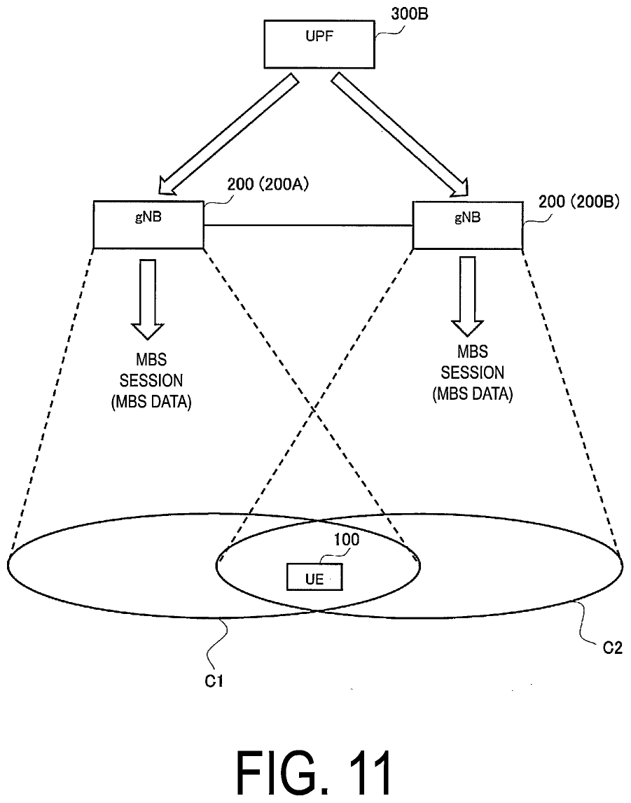

FIG. 11 is a diagram illustrating a first operation scenario of the mobile communication system 1 according to an embodiment.

A gNB 200A manages a cell C1, and a gNB 200B in a neighboring relationship with the gNB 200A manages a cell C2. Coverages of the cell C1 and the cell C2 at least partially overlap. The gNB 200A and the gNB 200B are connected to each other via an Xn interface being an interface between base stations. Inter-base station communication between the gNB 200A and the gNB 200B is performed on the Xn interface.

The gNB 200A provides an MBS session in the cell C1. Specifically, the gNB 200A receives MBS data belonging to the MBS session from a UPF 300B, and transmits the MBS data in the cell C1 through PTM (multicast/broadcast). The UE 100 in the RRC connected state performs reception (MBS reception) of the MBS data transmitted in the cell C1 through PTM. Reception of the MBS data (MBS reception) transmitted through PTM is also referred to as PTM reception.

The gNB 200B provides an MBS session in the cell C2. Specifically, the gNB 200B receives MBS data belonging to the MBS session from a UPF 300B, and transmits the MBS data in the cell C2 through PTM. The cell C2 constitutes the SFN with the cell C1, and the gNB 200B provides, in the cell C2, the same MBS session as the MBS session provided in the cell C1.

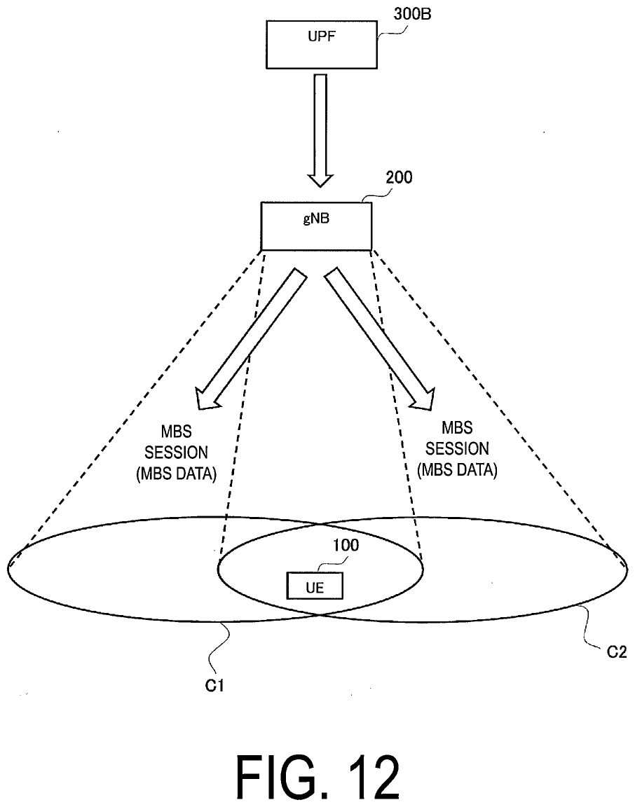

FIG. 12 is a diagram illustrating a second operation scenario of the mobile communication system 1 according to an embodiment.

The second operation scenario is different from the first operation scenario in that the cell C1 and the cell C2 are managed by one gNB 200. The gNB 200 provides an MBS session in each of the cell C1 and the cell C2. Specifically, the gNB 200 transmits the MBS data in each of the cell C1 and the cell C2 through PTM (multicast/broadcast). The cell C1 and the cell C2 constitute the SFN, and the gNB 200 provides the same MBS session in the cell C1 and the cell C2.

In the above-described scenario, for example, the UE 100 in the RRC connected state measures the reception quality of a reception signal and reports a measurement result to the network (gNB 200). The measurement for the SFN is considered to have the following problems.

In normal measurement reporting, measurement and reporting are intended for cells. For example, the UE 100 performs measurement on a synchronization signal/PBCH block (SSB) transmitted by each cell. The SSB includes a primary synchronization signal (PSS), a secondary synchronization signal (SSS), a demodulation reference signal (DMRS), and a physical broadcast channel (PBCH). The PBCH transmits MIB. The measured reception quality is, for example, reference signal received power (RSRP), a reference signal received quality (RSRQ), and/or a signal to interference noise ratio (SINR).

In such measurement on a cell-by-cell basis, even when the serving cell of the UE 100 and the neighboring cells constitute the SFN, the reception quality degrades when the UE 100 moves to the cell edge. Accordingly, the network (gNB 200) cannot accurately determine, based on the measurement reporting, the reception state of the UE 100 for the PTM transmitted in the SFN. Therefore, a problem is that the network (gNB 200) cannot appropriately perform, for example, switching from PTM to PTP or network optimization.

In the first embodiment, the UE 100 first receives MBS signals transmitted using the same identifier from a plurality of cells included in the SFN. The same identifier may be a group radio network temporary identifier (G-RNTI), a temporary mobile group identifier (TMGI), a multicast radio bearer (MRB) identifier, a logical channel identifier (LCID) of a multicast traffic channel (MTCH), or a multicast control channel radio network temporary identifier (MCCH-RNTI).

Secondly, the UE 100 measures the reception qualities of the MBS signals using the same identifier as a measurement target. The reception quality may be the RSRP, the RSRQ, the SINR, a bit error rate (BER), a frame error rate (FER), or a block error rate (BLER). For example, the UE 100 may measure the RSRP, the RSRQ, the SINR, the BER, the FER, or the BLER of the MBS signal on a per-G-RNTI basis, on a per-TMGI basis, on a per-MRB identifier basis, on a per-MTCH LCID basis, or on a per-MCCH-RNTI basis. The measurement may be performed when the UE 100 is in the RRC connected state. The measurement may be performed when the UE 100 is in the RRC idle state or RRC inactive state. A reference signal used for measuring the RSRP, the RSRQ, and the SINR is not limited to the SSB, and may be a channel state information reference signal (CSI-RS) or a DMRS.

Thirdly, the UE 100 reports, to the network (gNB 200), the measurement result obtained by the measurement. The UE 100 may report the same identifier associated with the measurement result to the network together with the measurement result.

Thus, the network (gNB 200) can accurately determine the reception state of the UE 100 for the PTM transmitted in the SFN, based on the measurement reporting from the UE 100. Therefore, the network (gNB 200) can appropriately perform, for example, switching from PTM to PTP and network optimization.

In the first embodiment, the UE 100 receives, from the network (gNB 200), a measurement configuration configuring the same identifier (i.e., the identifier used for the MBS signal in the SFN) as a measurement target. The UE 100 performs measurement based on the measurement configuration. Thus, the network (gNB 200) can specify the same identifier to be measured.

In the first embodiment, the measurement configuration may include a measurement reporting configuration for configuring measurement reporting. The measurement reporting configuration may include a trigger configuration for configuring a trigger condition for reporting a measurement result for the same identifier as a measurement target. The UE 100 may perform reporting (measurement reporting) in response to the measurement result satisfying the trigger condition. Thus, the network (gNB 200) can specify the identifier to be measured.

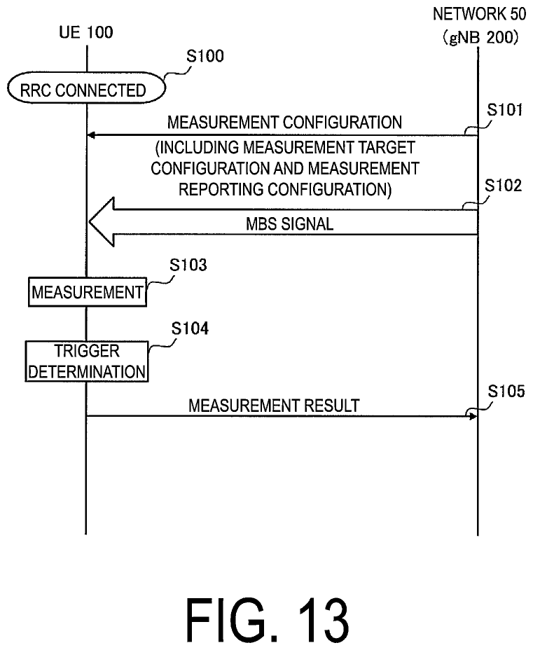

FIG. 13 is a diagram illustrating a first operation example according to the first embodiment.

In Step S100, the UE 100 is in the RRC connected state.

In Step S101, the network 50 (gNB 200) transmits, to the UE 100, UE-specific signaling including measurement configuration related to the measurement of the SFN. The UE-specific signaling may be an RRC Reconfiguration message.

The measurement configuration includes an identifier of a measurement target (G-RNTI, MBS session identifier (TMGI), MRB ID, MTCH LCID, or MCCH-RNTI) as a measurement target configuration. The measurement configuration may include designation of a channel such as measurement of the MCCH.

The measurement configuration includes a measurement reporting configuration for configuring the trigger condition for the measurement reporting. The trigger condition may be to configure an event for event-triggered measurement reporting. The trigger condition may be to configure periodic measurement reporting.

The event for event-triggered measurement reporting may be, for example, the following events for the identifier of the measurement target:
an event in which reception quality (e.g., RSRP, RSRQ, or SINR) is below or above a threshold;
an event in which MBS reception (PTM reception) has failed for a certain period of time or a certain number of times; and
an event in which the error rate (BER, FER, or BLER) is below or above a threshold.

In Step S102, the UE 100 receives the MBS signal from the network 50. Before receiving the MBS, the UE 100 receives the MBS reception configuration from the network 50.

In Step S103, the UE 100 performs measurement on the configured measurement target according to the measurement configuration in Step S101. Here, the UE 100 may perform measurement only during an ON duration in a pattern of the discontinuous reception (DRX) associated with the measurement target (G-RNTI or the like). The UE 100 may perform measurement only on the G-RNTI for which the UE 100 is interested in reception, the G-RNTI being received, or the like. The UE 100 may perform measurement only on the G-RNTI for which the UE 100 is not interested in reception, or the like. For the first delivery mode (DM1), the UE 100 may perform measurement only on the G-RNTI for which the gNB 200 has configured the MRB, or the like.

In Step S104, the UE 100 determines whether the trigger condition for the measurement reporting is satisfied. In this regard, the following description will be given on the assumption that the trigger condition is satisfied.

In Step S105, the UE 100 transmits, to the network 50, the measurement reporting including the measurement result obtained in Step S103. The measurement result (measurement reporting) includes the identifier (G-RNTI, MBS session identifier, MRB ID, MTCH LCID, or MCCH-RNTI) on which the measurement has been performed. The identifier may be provided with identification information such as the identifier (G-RNTI or the like) for which the UE is interested in reception, the identifier being received, or the identifier for which the UE is not interested in reception. The measurement result (measurement reporting) may include information indicating the frequency at and/or bandwidth part (BWP) in which the measurement has been performed.

Based on the measurement result (measurement reporting) from the UE 100, the network 50 (gNB 200) may change the bearer type from PTM to PTP or adjust the MCS of PTM.

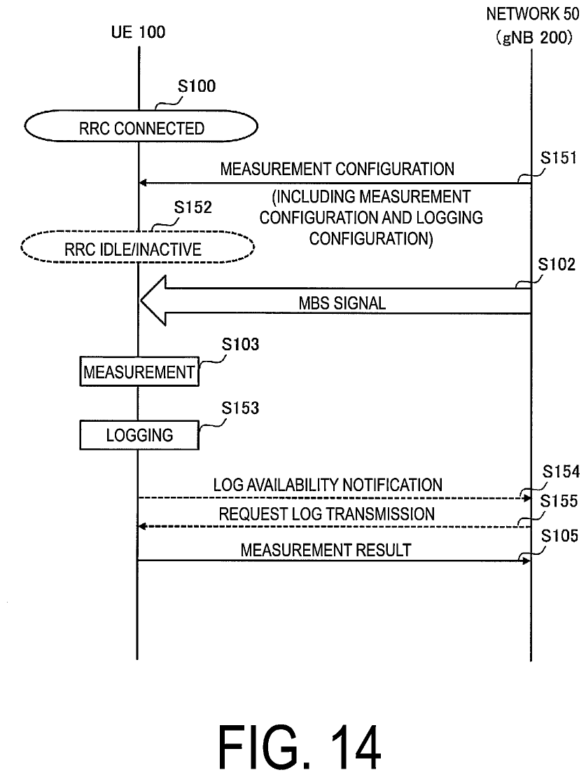

FIG. 14 is a diagram illustrating a second operation example according to a first embodiment. In the second operation example, the UE 100 executes processing of recording a measurement result (hereinafter referred to as “logging”). Here, differences from the first operation example described above will be described.

In Step S151, the network 50 (gNB 200) transmits, to the UE 100, UE-specific signaling including the measurement configuration as described above. Although the information included in the measurement configuration is similar to the above-described information, the above-described “trigger condition” may be interpreted as a “logging condition”.

In Step S152, the UE 100 may transition from the RRC connected state to the RRC idle state or the RRC inactive state.

In Step S153, the UE 100 stores (logs) the measurement result obtained in Step S103. The UE 100 may store, as a measurement log, the measurement result together with UE position information and/or a timestamp.

In Step S154, the UE 100 may send to, the network 50, a log availability notification indicating that the UE 100 has a measurement log. For example, the UE 100 may send the notification during a random access procedure for access to the network 50.

In Step S155, the network 50 (gNB 200) may transmit, to the UE 100, a log transmission request for transmission of the measurement log.

Upon receiving the measurement result (measurement log) in Step S105, the gNB 200 may transfer the measurement result (measurement log) to Operations, Administration, Maintenance (OAM).

### Second Embodiment

A second embodiment will be described mainly regarding differences from the first embodiment described above. The second embodiment is an embodiment related to a cell reselection procedure performed by the UE 100 in the RRC idle state or the RRC inactive state in the network 50 configured with the SFN.

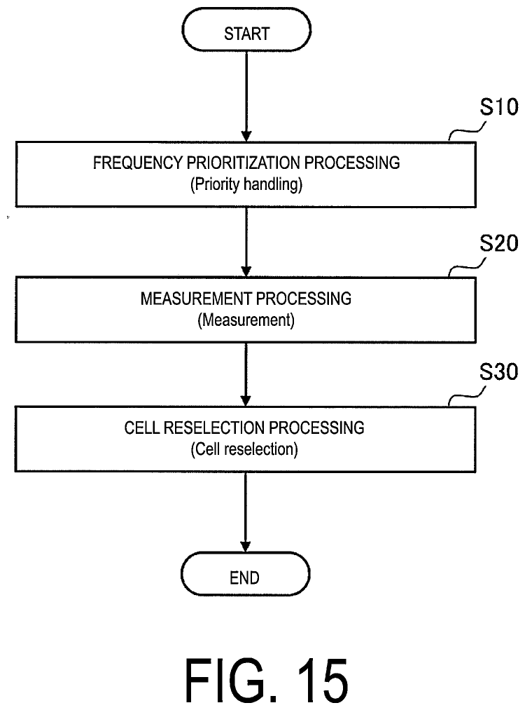

An overview of the cell reselection procedure will be described. FIG. 15 is a general flow illustrating a typical cell reselection procedure.

In Step S10, the UE 100 performs frequency prioritization processing based on a priority (also referred to as an “absolute priority”) for each of the frequencies specified by the network 50 (gNB 200) using, for example, a system information block (SIB) or an RRC Release message. To be more specific, the UE 100 manages frequency priorities specified by the network 50 (gNB 200) for the respective frequencies.

In Step S20, the UE 100 executes measurement processing of measuring the radio qualities of the serving cell and the neighboring cell. The UE 100 measures the received power and reception quality of a reference signal, to be more specific, a Cell Defining-Synchronization Signal and PBCH block (CD-SSB), transmitted by each of the serving cell and the neighboring cell. For example, the UE 100 always measures the radio quality for frequencies having a higher priority than the frequency of the current serving cell, and for frequencies having a priority equal to or lower than the priority of the frequency of the current serving cell, measures the radio quality of the frequency having the priority equal to or lower than the priority of the frequency of the current serving cell when the radio quality of the current serving cell is below a predetermined quality.

In Step S30, the UE 100 executes cell reselection processing of reselecting a cell on which the UE 100 is to camp based on the measurement result in Step S20. The UE 100 may perform cell reselection on the neighboring cell when the frequency of the neighboring cell has a higher priority than the frequency of the current serving cell and the neighboring cell satisfies a predetermined quality standard for a predetermined period of time (in other words, the minimum quality standard), for example. When the frequency of the neighboring cell has the same priority as the frequency of the current serving cell, the UE 100 may rank the radio quality of the neighboring cell and may perform cell reselection to reselect the neighboring cell having a higher rank than the rank than the current serving cell for a predetermined period of time. When the frequency of the neighboring cell has a lower priority than the frequency of the current serving cell, the radio quality of the current serving cell is lower than a certain threshold value, and the radio quality of the neighboring cell is continuously higher than another threshold value for the predetermined period of time, the UE 100 may perform cell reselection to reselect the neighboring cell.

Under such an assumption, when performing MBS reception from the SFN in the RRC idle state or the RRC inactive state, the UE 100 can easily perform continuous MBS reception by using any of the cells included in the SFN as a reselection candidate.

In the second embodiment, the UE 100 receives MBS signals transmitted using the same identifier from a plurality of cells included in the SFN. In the cell reselection procedure, the UE 100 in the RRC idle state or the RRC inactive state performs priority control of prioritizing cells included in the SFN over cells not included in the SFN.

In the second embodiment, the UE 100 may receive, from the network 50 (gNB 200), a notification indicating that priority control is permitted to be performed. The UE 100 may perform priority control only when the notification is received from the network 50 (gNB 200).

In the second embodiment, the UE 100 may receive, from the network 50 (gNB 200), SFN information indicating an MBS session provided by the SFN. When the information indicates that the SFN provides the MBS session that the UE 100 is receiving, the UE 100 may determine the frequency to which the current serving cell of the UE 100 belongs to have the highest priority as the frequency priority to be used in the cell reselection procedure.

In the second embodiment, the UE 100 may receive, from the network 50 (gNB 200), a list including the identifier of each of the cells included in the SFN. For example, the UE 100 may receive, from the serving cell included in the SFN, a list of neighboring cells included in the SFN. In the cell reselection procedure, the UE 100 may control cell reselection to preferentially reselect a cell (neighboring cell) indicated in the list over a cell (neighboring cell) not indicated in the list.

In the second embodiment, when the UE 100 reselects any of the neighboring cells included in the SFN, the UE 100 may omit (skip) reception of the MCCH from the neighboring cell and receive the MTCH from the neighboring cell.

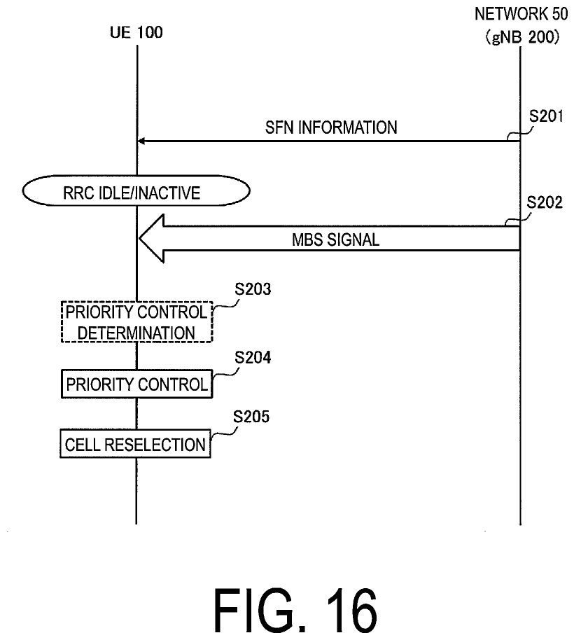

FIG. 16 is a diagram illustrating an operation example according to the second embodiment.

In Step S201 the network 50 (gNB 200) transmits, to the UE 100, SFN information related to the SFN. The UE 100 in the RRC connected state, the RRC idle state, or the RRC inactive state receives the SFN information. The network 50 (gNB 200) may transmit, to the UE 100, the SIB, MCCH, RRC Reconfiguration message, or RRC Release message including the SFN information.

The SFN information may be information (identifier) indicating MBS sessions constituting the SFN. For example, the SFN information may include an MBS session identifier (e.g., TMGI), an MRB ID, an MTCH LCID, and a G-RNTI (hereinafter referred to as the “MBS session identifier and the like”). The SFN information may be an identifier indicating, in the MRB configuration or the MTCH configuration information, whether the MBS session constitutes the SFN. The SFN information may include a list of MBS session identifiers constituting the SFN, and the like. The SFN information may include, for each MBS session identifier or the like, (a list of) cell IDs of neighboring cells included in the SFN.

In Step S201, the network 50 (gNB 200) may notify the UE 100 of information indicating whether any of the cells included in the SFN may be preferentially reselected. The notification may explicitly be an information element such as “allowed”. The notification of the SFN information may implicate “allowed”.

In Step S202, the UE 100 in the RRC idle state or the RRC inactive state may perform MBS reception (PTM reception).

When the MBS session being received constitutes the SFN, the UE 100 in the RRC idle state or the RRC inactive state executes the following processing in the cell reselection procedure.

The UE 100 may determine whether priority reselection of the SFN cell is allowed (Step S203). When priority reselection of the SFN cell is allowed, the UE 100 may perform a normal cell reselection procedure.

The UE 100 may consider the frequencies priority of the current serving frequency (i.e., the frequencies to which the cells included in the SFN belong) as the highest priority (Step S204). As a result, the UE 100 preferentially reselects an inter-frequency cell, i.e. any of the cells included in the SFN (Step S205).

In the ranking, the UE 100 may add an offset to the current serving cell and/or the neighboring cells included in the SFN (Step S204). For example, the UE 100 adds an offset to the ranking (or the radio quality value) in such a manner that the cells included in the SFN rank higher. The gNB 200 may configure the offset value for the UE 100 using the SIB, MCCH, RRC Reconfiguration, or RRC Release.

After reselecting any of the neighboring cells included in the SFN, the UE 100 may skip reception of the MCCH from the neighboring cell (Step S205).

### Third Embodiment

A third embodiment will be described mainly in terms of differences from the first embodiment and the second embodiment described above.

In the third embodiment, the UE 100 in the RRC idle state or the RRC inactive state receives an MBS session (e.g., a multicast session) to which the first delivery mode (DM1) is applied. For example, a scenario is assumed in which, with the UE 100 receiving the MBS session in the RRC connected state, the load on the network 50 (gNB 200) increases, and the network 50 (gNB 200) temporarily transitions the UE 100 to the RRC idle state or the RRC inactive state. Upon transitioning to the RRC idle state or the RRC inactive state, the UE 100 can continue MBS reception for a certain period (predetermined amount of time) using the configuration of the first delivery mode. However, the UE 100 may cancel the configuration of the first delivery mode after the certain period (predetermined amount of time) has elapsed. In this case, the UE 100 desiring to continue the MBS reception transitions to the RRC connected state and acquires the configuration of the first delivery mode from the network 50 (gNB 200).

In the third embodiment, in the RRC connected state, the UE 100 receives the MBS reception configuration (that is, the configuration of the first delivery mode) transmitted by dedicated signaling from the network 50 (gNB 200) to the UE 100. The MBS reception configuration may include the above-described MTCH configuration information. The UE 100 performs MBS reception using the MBS reception configuration for a predetermined amount of time after transitioning to the RRC idle state or the RRC inactive state. The dedicated signaling may include information for specifying the predetermined amount of time.

In the third embodiment, the UE 100 may transition to the RRC connected state in response to the elapsing of the predetermined amount of time. After transitioning to the RRC connected state, the UE 100 may receive a new MBS reception configuration transmitted by the dedicated signaling from the network 50 (gNB 200) to the UE 100.

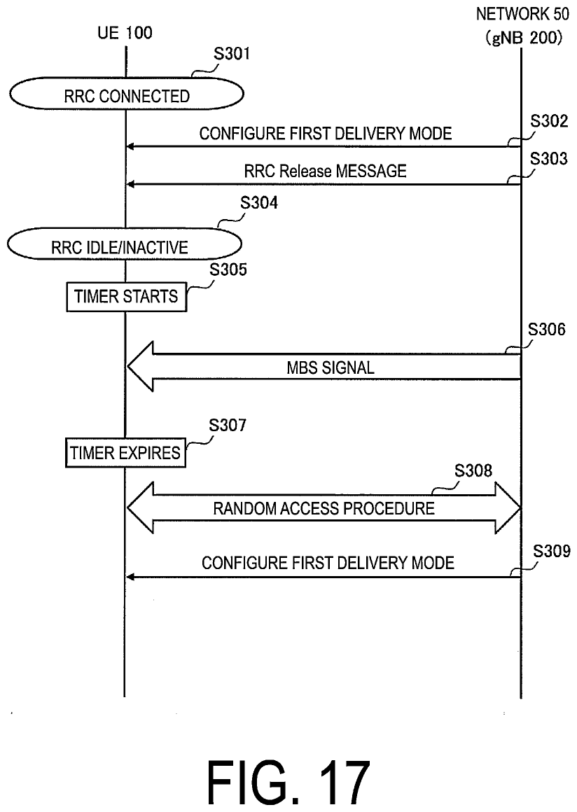

FIG. 17 is a diagram illustrating an operation example according to the third embodiment.

In Step S301, the UE 100 is in the RRC connected state.

In Step S302, the UE 100 receives, from the network 50 (gNB 200), the RRC Reconfiguration message including the configuration of the first delivery mode. The UE 100 may start PTM reception using the configuration of the first delivery mode.

In Step S303, the network 50 (gNB 200) transmits the RRC Release message to the UE 100.

In Step S304, the UE 100 transitions to the RRC idle state or the RRC inactive state upon reception of the RRC release message.

In the RRC idle state or the RRC inactive state, the UE 100 may continue to apply the configuration of the first delivery mode received in the RRC Reconfiguration message (Step S302). Alternatively, the RRC Release message (Step S303) may provide the UE 100 again with the configuration of the first delivery mode. The configuration of the first delivery mode includes an expiration date (timer value) corresponding to the above-described predetermined amount of time.

In Step S305, upon transiting to the RRC idle state or the RRC inactive state, the UE 100 starts a timer with the expiration date (timer value) set therein.

In Step S306, the UE 100 continues the PTM reception using the configuration of the first delivery mode while the timer is running.

In Step S307, the UE 100 detects expiry of the timer.

In Step S308, the UE 100 performs a random access procedure with the network 50 (gNB 200) in response to expiry of the timer. The UE 100 transmits an RRC Setup Request message or an RRC Resume Request message constituting Message 3 (Msg3) of the random access procedure to request an RRC connection. The UE 100 may start the random access procedure before the timer expires. Note that there may be two timers, one of which triggers the RRC connection request, and the other of which indicates the validity period of the configuration of the first delivery mode (triggers configuration cancellation).

Note that, when not interested in the MBS service (MBS session) upon expiry of the timer, the UE 100 need not request the RRC connection. In that case, the UE 100 may cancel the MRB configuration and maintain the RRC idle state or the RRC inactive state.

In Step S308, the UE 100 may notify the gNB 200 of a request for (only) update of the configuration of the first delivery mode. For example, the UE 100 may include, in the RRC Setup Request message or the RRC Resume Request message, an information element (Establishment Cause, Resume Cause) indicating a request for (only) update of the configuration of the first delivery mode. Alternatively, the UE 100 may notify the request for (only) update of the configuration of the first delivery mode, in Message 5 (Msg5) of the random access procedure or subsequently in a UE Assistance Information message. When using Msg5 or the UE Assistance Information message, the UE 100 may further notify an MBS session identifier (TMGI) the configuration of which is desired to be updated.

In Step S309, upon accepting the request, the network 50 (gNB 200) configures the UE 100 with the first delivery mode. The network 50 (gNB 200) may configure the first delivery mode again. The network 50 (gNB 200) may notify the UE 100 of only an identifier indicating that the current configuration is continuously applied. After the configuration, the network 50 (gNB 200) may transition the UE 100 into the RRC idle state or RRC inactive state again.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiments and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a DU of the IAB node. The user equipment may be a Mobile Termination (MT) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, system on a chip (SoC)).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### REFERENCE SIGNS

1: Mobile communication system
10: RAN
20: CN
100: UE
110: Receiver
120: Transmitter
130: Controller
200: gNB
210: Transmitter
220: Receiver
230: Controller
240: Backhaul communicator

1. A communication method performed by a user equipment in a radio resource control (RRC) idle state or an RRC inactive state in a mobile communication system for providing a multicast and broadcast service (MBS), the communication method comprising:
receiving an MBS signal transmitted using an identical identifier from a plurality of cells included in a single frequency network (SFN); and
performing, in a cell reselection procedure, priority control of prioritizing cells included in the SFN over cells not included in the SFN.

2. The communication method according to claim 1, further comprising:
receiving, from a network, a notification indicating that the priority control is permitted to be performed,
wherein the performing of the priority control comprises performing the priority control only when the notification is received from the network.

3. The communication method according to claim 1, further comprising:
receiving, from the network, SFN information indicating an MBS session provided by the SFN,
wherein the performing of the priority control comprises determining a frequency to which a current serving cell of the user equipment belongs to have a highest priority as a frequency priority used in the cell reselection procedure, when the SFN information indicates that the MBS session that the user equipment is receiving is provided by the SFN.

4. The communication method according to claim 1, further comprising:
receiving, from the network, a list comprising an identifier of each of the plurality of cells included in the SFN,
wherein the performing of the priority control comprises controlling cell reselection to preferentially reselect, in the cell reselection procedure, one of the plurality of cells indicated in the list over a cell not indicated in the list.

5. The communication method according to claim 1, further comprising:
omitting, when a neighboring cell among the plurality of cells included in the SFN is reselected, reception of a multicast control channel (MCCH) from the neighboring cell, and receiving a multicast traffic channel (MTCH) from the neighboring cell.

6. A user equipment in a radio resource control (RRC) idle state or an RRC inactive state in a mobile communication system for providing a multicast and broadcast service (MBS), the user equipment comprising:
a receiver configured to receive an MBS signal transmitted using an identical identifier from a plurality of cells included in a single frequency network (SFN); and
a circuitry configured to perform, in a cell reselection procedure, priority control of prioritizing cells included in the SFN over cells not included in the SFN.
